(19) United States
(12) Patent Application Publication
(10) Pub. No.: US 2021/0217040 A1
(43) Pub. Date: Jul. 15, 2021

(54) SYSTEMS AND METHODS OF TRACKING ENTITY PROGRAM PARTICIPANT ACTIVITY ON SOCIAL MEDIA THROUGH ENTITY ACCOUNT ON SOCIAL MEDIA

(71) Applicant: LoudCrowd, Inc., Austin, TX (US)

(72) Inventors: Gary Adam Garofalo, Austin, TX (US); Austin Alexander Arnold, Austin, TX (US)

(21) Appl. No.: 17/127,802

(22) Filed: Dec. 18, 2020

Related U.S. Application Data
(60) Provisional application No. 62/950,645, filed on Dec. 19, 2019.

(51) Int. Cl. G06Q 30/02; G06Q 50/00

(52) U.S. Cl. CPC G06Q 30/0224; G06Q 30/0239; G06Q 50/01

(57) ABSTRACT

A system obtains and/or receives input data that tags/mentions an entity from a social media platform. The system transforms the input data for a reward analysis, including parsing a payload from the social media platform to extract a social media user name, the tag, the mention, or a combination thereof, mapping the social media user name to a reward program participant having addressable user information, and populating a plurality of database tables with media objects and media metadata from the social media platform and a mapping between the social media user name and the reward program participant. The system analyzes the plurality of database tables against trigger points defined in a reward structure associated with the entity and determines whether the reward program participant is eligible for a reward. If so, the system automatically delivers the reward to the reward program participant using the addressable user information.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### CROSS-REFERENCE TO RELATED APPLICATION(S)

This application claims a benefit of priority under 35 U.S.C. § 119(e) from U.S. Provisional Application No. 62/950,645, filed Dec. 19, 2019, entitled “SYSTEMS AND METHODS OF TRACKING ENTITY PROGRAM PARTICIPANT ACTIVITY ON SOCIAL MEDIA THROUGH ENTITY ACCOUNT ON SOCIAL MEDIA,” the entire disclosure of which is fully incorporated by reference herein for all purposes.

### TECHNICAL FIELD

This disclosure relates generally to social media on the Internet. More particularly, embodiments disclosed herein relate to systems and methods of tracking, through an entity's account on a social networking site or application, activities of entity program participants on the social networking site or application, useful for monitoring and tracking user-generated content in the context of an entity rewards or incentive program on the Internet.

### BACKGROUND OF THE RELATED ART

Today, many entities use social media to encourage action among their audience. The term “social media” generally refers to websites and applications that enable users to create and share content or to participate in social networking. Examples of social networking sites and applications include, but are not limited to, Facebook®, LinkedIn®, Twitter®, Instagram®, etc. All trademarks, service marks, and logos used herein are properties of their respective companies.

Some social media platforms such as Instagram® allow third-party service providers, applications, websites, and the likes (which are collectively referred to herein as third-party entities) to pull certain social media data using social media application programming interfaces (APIs) provided by the social media platforms. For instance, a third-party entity, which is authorized by an entity (e.g., a company, a brand, an influencer, etc.) having an entity social media account on a social media platform, can make an API call to the social media platform as permitted by the entity to obtain social media data pertaining to the entity (e.g., a post made by the entity, a post made by a social media user to the entity's social media account, etc.).

As illustrated in this example, the entity's authorization is needed by the third-party entity to access the entity's social media data on the social media platform. That is, generally, social media platforms do not allow third-party entities to use APIs provided by the social media platforms to pull social media data on social media user accounts of interest without prior authorizations from the owners of such social media user accounts. For instance, a user may post a picture of a purse on a social media platform and tag the brand of the purse. The user-posted image tagged with the brand is now associated with the brand's social media account and becomes part of the brand's social media data. This means that a third-party entity can, as authorized by the brand, obtain information about the user-posted image tagged with the brand from the social media platform via an API provided by the social media platform. However, since the third-party entity does not have the user's authorization to access the user's social media data on the social media platform, there is no way for the third-party entity to obtain the user's social media data from the social media platform. Consequently, the third-party entity has no way of tracking and/or measuring how many times the user has tagged the brand on the social media platform.

Further, while the third-party entity can, as authorized by the brand, make an API call to the social media platform to pull information about the user-posted image tagged with the brand, the response from the social media platform does not contain any addressable information about the user (e.g., an email address or phone number), other than a social media user name of the user, due to data protection regulations, privacy laws, data security rules, and so on. Consequently, there is no way for the third-party entity to contact the user (e.g., by email or by phone).

Given the restrictions imposed by the social media platforms on social media data and in view of the lack of meaningful ways to measure user activities pertaining to an entity of interest on the social media platforms, currently, there is no way for third-party entities to programmatically systematically identify and reward social media users for tagging and/or mentioning an entity of interest on a social media platform. Rather, the only way to potentially reward a social media user for tagging or mentioning an entity of interest on a social media platform is to manually examine every photo in which the entity of interest is tagged and every caption in which the entity of interest is mentioned and then manually select those made by social media users who have signed up with the entity's reward program and manually determine whether those social media users have met the requirements of the entity's reward program. With millions of posts taking places on a daily basis, this manual approach is practically impossible in today's digital world. To make the issue worse, the third-party entity which services the entity's reward program does not have an efficient or effective way to contact a reward recipient directly without going through a social media platform.

Accordingly, there is a need for innovations and improvements in tracking, through an entity's account on a social media platform on the Internet, activities of entity program participants on the social media platform, useful for monitoring and tracking user-generated content in the context of an entity rewards or incentive program. The invention disclosed herein can address this need and more.

### SUMMARY OF THE DISCLOSURE

Embodiments disclosed herein can address the aforementioned drawbacks and provide additional technical solutions and benefits. A goal of the invention is to provide an ability for third-party entities (e.g., third-party service providers, applications, and websites, or the likes) to automatically programmatically measure activities of social media users on social media platforms (e.g., social networking sites, social networking applications, etc.) with respect to an entity of interest (e.g., a company, a brand, an influencer, or the like that has set up a program, workflow, or process to reward or otherwise incentivize social media users to tag, mention, or otherwise include the entity of interest in their user-generated/shared content posted on the social media platforms).

In some embodiments, this goal is achieved in a computer system that implements an automated method comprising obtaining and/or receiving input data through a social media API, transforming the input data for a reward analysis, analyzing the transformed data for reward eligibility, determining a reward for a reward program participant, and delivering the reward to the reward program participant. The system is authorized by an entity of interest to make the API call to the social media platform on behalf of the entity of interest.

The system may be owned and/or operated by a third-party entity that services a program, workflow, process, or the like that the entity of interest uses to reward or otherwise incentivize social media users to tag, mention, or otherwise include the entity of interest in generating, tagging, and/or sharing content on the social media platform. The input data contained in a response from the social media platform, therefore, can include a tag or a mention and a social media user name of the social media user who tagged or mentioned the entity of interest on the social media platform.

In some embodiments, the system is operable to transform or otherwise prepare the input data for a reward analysis. Such data transformation operations can include parsing the response from the social media platform, extracting media objects and media metadata such as a social media user name and a timestamp, populating database tables to include the media objects and media metadata, mapping the social media user name to an addressable program participant identifier, etc. In some embodiments, normalization and/or data cleansing operations may be performed to remove irrelevant and/or non-conforming data so that the reward analysis can perform faster and/or more efficiently.

In some embodiments, the system is operable to analyze the transformed data for reward eligibility. This can include analyzing the media metadata, eliminating media objects that do not meet the reward criteria and/or program requirements, applying reward eligibility rules to reward-qualifying social media content (e.g., tags, mentions, etc.) associated with social media users who are identified by the system as reward program participants.

Based on results from the reward analysis, the system is operable to determine which reward program participant is to receive a reward. Because of the internal mapping between a social media user and a reward program participant, the system has addressable information about the social media user and can automatically programmatically deliver the reward to the social media user, for instance, by email or direct message, etc.

One embodiment comprises a system comprising a processor and a non-transitory computer-readable storage medium that stores computer instructions translatable by the processor to perform a method substantially as described herein. Another embodiment comprises a computer program product having a non-transitory computer-readable storage medium that stores computer instructions translatable by a processor to perform a method substantially as described herein. Numerous other embodiments are also possible.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure includes all such substitutions, modifications, additions and/or rearrangements.

### BRIEF DESCRIPTION OF THE DRAWINGS

The drawings accompanying and forming part of this specification are included to depict certain aspects of the invention. A clearer impression of the invention, and of the components and operation of systems provided with the invention, will become more readily apparent by referring to the exemplary, and therefore non-limiting, embodiments illustrated in the drawings, wherein identical reference numerals designate the same components. The features illustrated in the drawings are not necessarily drawn to scale.

FIG. 1 depicts a diagrammatic representation of a network computing environment where embodiments disclosed herein can be implemented.

FIG. 2 depicts a diagrammatic representation of a reward program page which includes a signup form according to some embodiments disclosed herein.

FIG. 3 depicts a flow diagram illustrating a data flow from social media sources and program participants to a third-party entity system having a plurality of database tables, a reward analyzer, and an automated reward delivery ecosystem according to some embodiments disclosed herein.

FIG. 4 is a flow chart illustrating an example of a method for tracking activities of an entity program participant on a social media platform through an entity account on the social media platform according to some embodiments disclosed herein.

FIGS. 5-11 show examples of database tables utilized by a reward analyzer in processing input data from social media sources, transforming the input data to internal representations, mapping the transformed input data to addressable user information, and applying rules to the mapped data according to some embodiments disclosed herein.

FIG. 12 shows an example of a program tier table utilized by a reward analyzer in determining reward eligibility according to some embodiments disclosed herein.

FIG. 13 shows an example of a reward delivery action table utilized by an automated reward delivery ecosystem according to some embodiments disclosed herein.

FIG. 14 depicts a diagrammatic representation of a data processing system for implementing embodiments disclosed herein.

### DETAILED DESCRIPTION

The invention and the various features and advantageous details thereof are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating some embodiments of the invention, are given by way of illustration only and not by way of limitation. Various substitutions, modifications, additions, and/or rearrangements within the spirit and/or scope of the underlying inventive concept will become apparent to those skilled in the art from this disclosure.

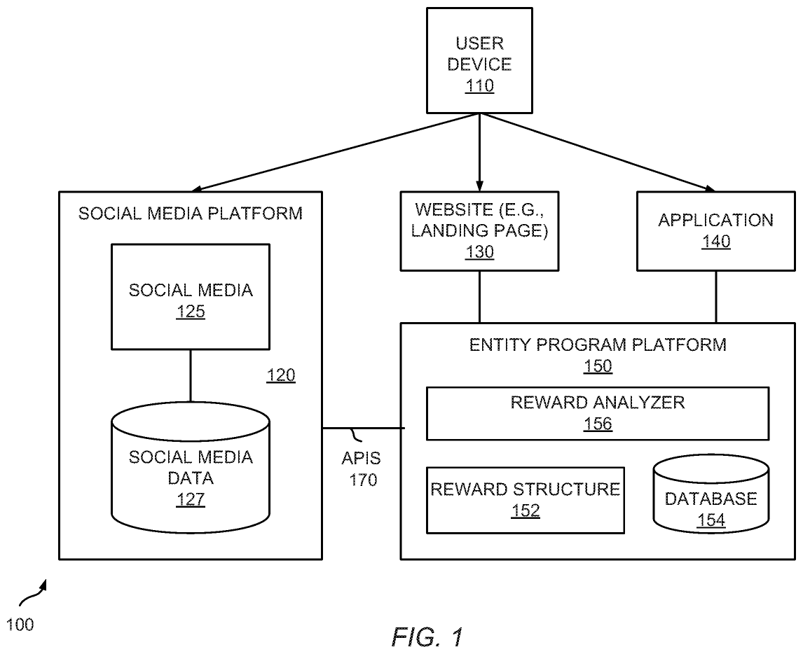

FIG. 1 depicts a diagrammatical representation of a network environment 100 in which embodiments disclosed herein can be implemented. In this example, an entity (e.g., a company, a brand, an influencer, etc.) having a presence on social media 125 hosted on a social media platform 120 may create an entity program, process, or workflow (e.g., a reward program, an incentive program, a promotional program, a campaign, etc., collectively referred to herein as the reward program) through an entity program platform 150. Entity program platform 150 may be owned and/or operated by a third-party entity that services the reward program. The third-party entity may operate independently of social media platform 120 and/or the entity.

An authorized user of the entity may log into entity program platform 150 and give entity program platform 150 permission to access social media data 127 through APIs 170 provided by social media platform 120. The authorized user of the entity or brand can also identify and/or create a reward structure 152 for the entity reward program.

In some embodiments, social media data 127 may include tags, caption mentions, or a combination thereof, in which the entity is tagged, mentioned, or otherwise included. In some embodiments, the invention utilizes APIs 170 provided by social media platform 125 to obtain and/or receive social media data 127 as input to a reward analyzer 156.

In some embodiments, APIs 170 can include a Graph API, a caption mentions API, etc.

Generally, the Graph API refers to an HyperText Transport Protocol (HTTP)-based API that applications can use to programmatically query data, post new stories, manage ads, upload photos, and perform a wide variety of other tasks. As a non-limiting example, Facebook® provides a Graph API as the primary way for third-party applications to read and write to the Facebook® social graph.

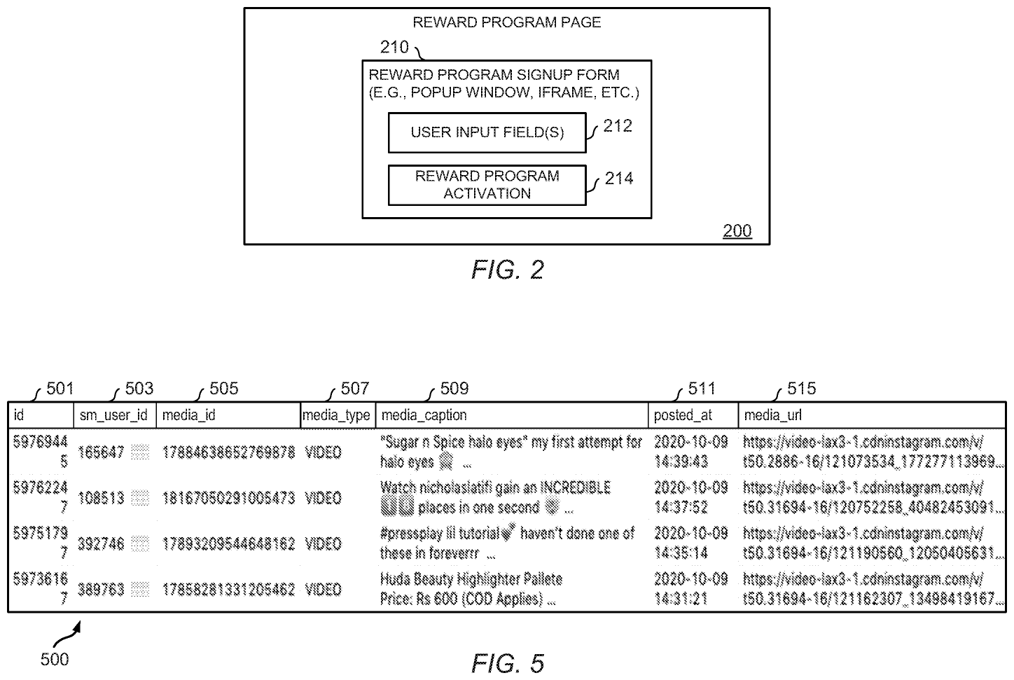

The entity may create a website 130 and/or an application 140 with a landing page, a signup form, or the like for users (e.g., non-entity users of social media 125) to join or otherwise participate in the reward program. This is further described below with reference to FIG. 2.

FIG. 2 depicts a diagrammatic representation of a reward program page 200. In some embodiments, a workflow can be created (e.g., by an administrator or authorized user of the entity or the third-party entity system that supports the reward program) to allow end users (e.g., a user associated with user device 110) to sign up for rewards. As illustrated in FIG. 2, reward program page 200 may include a signup form, popup window, page, iFrame, etc. 210 that is provided by the third-party entity system and that contains one or more user input fields 212.

If the user is required to sign in to reward program page 200 using an addressable identifier such as an email address, the third-party entity would have the email address of the user. In such a case, signup form 210 only needs a single user input field 212 for the user to provide a social media user name.

Otherwise, signup form 210 may include multiple user input fields for the user to enter their social media user name and addressable user information. In this disclosure, “addressable user information” refers to information that can be used to distinguish or trace an individual's identity, either alone or when combined with other personal or identifying information that is linked or linkable to a specific individual, for instance, an email address, phone number, home address, reward program account number, third-party entity user account number, or other types of personally identifiable information (PII). As further described below, information collected or otherwise gathered from each reward program participant through the sign up form, landing page, or the like, can be captured and stored in a program participant table.

Referring to FIG. 1, by repurposing Graph API 170 that is used to identify what media objects (e.g., which can be stored on social media platform 120 as part of social media data 127) in which the entity is tagged and/or mentioned, a system operating on entity program platform 150 (e.g., a third-party entity system) can capture a list of every media object that the entity has been tagged/mentioned in and store same in a database 154 on entity program platform 150. The entity, or an operator acting on behalf of the entity (e.g., an operator of the third-party entity system), can query database 154 for metadata associated with the tagged media objects. As discussed below, included within that metadata is the social media user name (or “username”) of the person (e.g., a user on user device 110) that, for instance, posted the media and tagged the entity. The system captures that username and stores it as its own object in database 154.

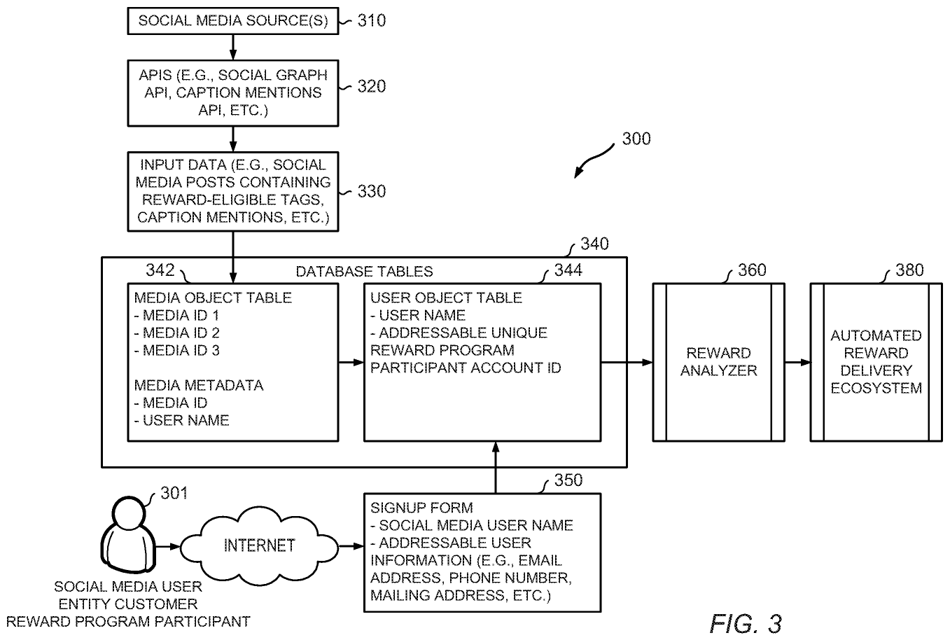

The system also captures the list of media objects and stores the media objects in a table, with each media object being associated with a user object. As illustrated in FIG. 3, which shows a flow of data from social media source(s) (310) through APIs (320) as input (330) to database tables (340) of a system 300. System 300 is adapted for mapping media objects in the input data to username objects in the input data and storing them in media object table 342 and user object table 344, respectively.

System 300 is further adapted for mapping social media user names to addressable reward program participants (e.g., by accounts, identifiers, etc.). This mapping enables social media user names to become programmatically addressable. The addressable information can be obtained by system 300 through signup forms 350 presented to users 301 over the Internet. For instance, a workflow can be created (e.g., by an administrator or authorized user of system 300 or of the entity) to allow user 301 to sign up for rewards, as discussed above with reference to FIG. 2.

In the example of FIG. 3, system 300 includes a reward analyzer 360 adapted for analyzing information stored in database tables 340 for reward eligibility of reward program participants. In some embodiments, system 300 can further include an automated reward delivery ecosystem 380 in which a reward can be delivered programmatically automatically in various ways (e.g., by email, direct message, reward program account, etc.) to a reward recipient identified and qualified by system 300.

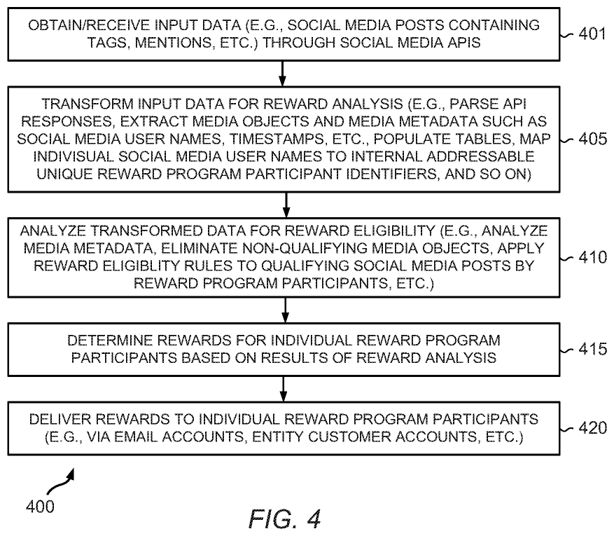

FIG. 4 is a flow chart that illustrates an example of a computer-implemented method 400 implemented by system 300. Method 400 may include obtaining/receiving input data from a social media platform (401), transforming the input data for a reward analysis (405), analyzing the transformed data for reward eligibility (410), determining a reward for a reward program participant (415), and delivering the reward to the reward program participant (420).

More specifically, in some embodiments, at least two types of input data are involved: tags and mentions. The system is configured for receiving, for instance, via a webhook and mentions API provided by a social media platform, mentions associated with an entity of interest from a social media source as they occur on the social media platform. The tags do not come into the system automatically. Rather, the system is configured for obtaining tags associated with the entity of interest from the social media via, for instance, a Graph API provided by the social media platform.

The input data thus arrived at the system is then transformed or rationalized for internal operations (e.g., internal to the third-party entity system). The data transformation utilizes a plurality of tables, some of which are shown in FIGS. 5-13.

FIG. 5 shows an example of a social media table 500 structured for storing social media posts and stats. In the example of FIG. 5, social media table 500 includes a plurality of data fields such as an internal identifier (ID) 501, social media user ID (sm_user_id) 503, media ID 505, media type 507, media caption 509 where an entity of interest is mentioned, posted date 511, and media universal resource locator (URL) 515. In this case, social media user ID (sm_user_id) 503 has a numerical representation, rather than a text string. Alternatively, user names in text strings could be stored in social media table 500 and mapped to corresponding numerical representations in a separate table.

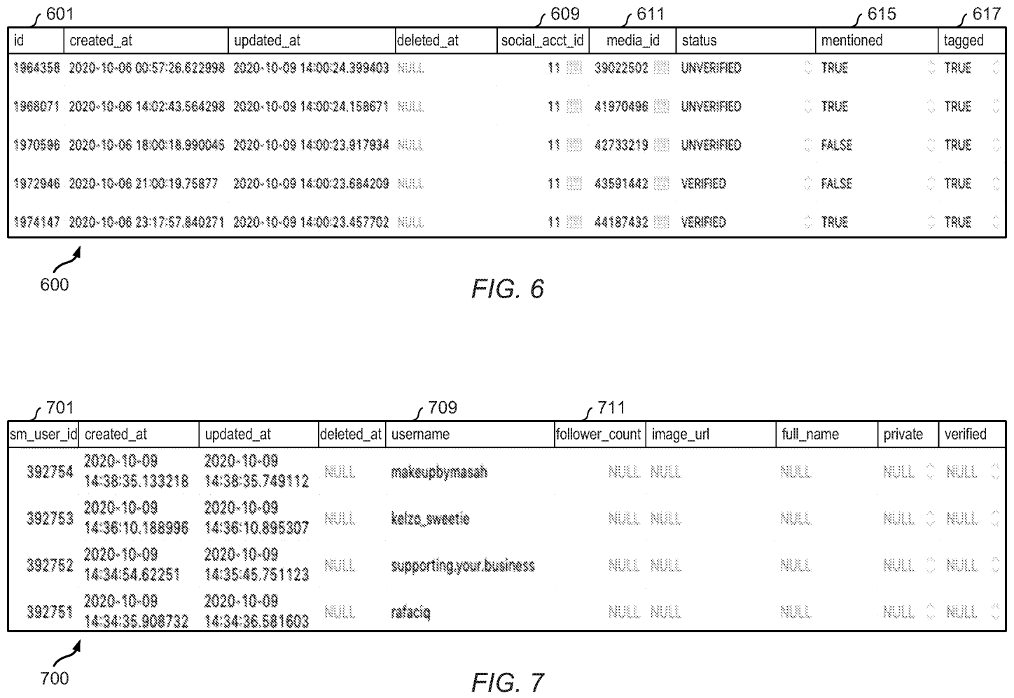

FIG. 6 shows an example of a social media tag table 600 structured for associating social media posts with respective entities of interest. In the example of FIG. 6, social media tag table 600 includes a plurality of data fields such as an internal ID 601, social account ID 609, media ID 611, and flags 615, 617 that indicate whether the entity of interest is mentioned and/or tagged. While social account ID 609 is for identifying an entity of interest on the social media platform, media ID 611 is for identify the media involved in the corresponding tag or mention. As a non-limiting example, the system may operate to obtain tags from a social media platform and update social media tag table 600 on a periodic time window (e.g., an hour). In one embodiment, once social media tag table 600 is updated, a social media mentions table is also updated.

FIG. 7 shows an example of a social media user table 700 structured for associating social media users with respective social media user names. In the example of FIG. 6, social media user table 700 includes a plurality of data fields such as social media user ID 701 (in numerical representations) mapped to social media user names 709. Social media user table 700 can include other types of information parsed from the API responses (e.g., the number of followers 711 associated with a social media user).

Referring to FIG. 2, as discussed above, signup forms for a reward program can be provided by the system via a landing page or web property. Upon activation (e.g., by pressing or selecting user interface element 214 shown in FIG. 2) of the user's participation in the reward program, the user joins the reward program and data value(s) from input field(s) 212 are provided to the system. In turn, the system stores user-provided information, particularly the addressable user information, in a program participant table.

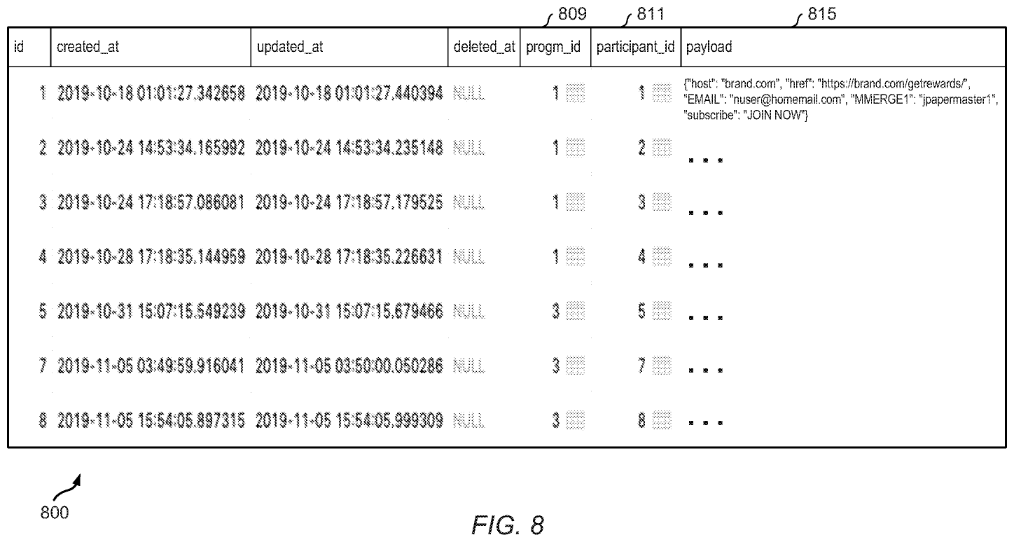

FIG. 8 shows an example of a program participant table 800 populated with user-provided data. In this example, program participant table 800 is structured for storing, e.g., reward program ID 809 for each associated entity program (e.g., “progm_id”), reward program participant ID 811 for each reward program participant (e.g., “participant_id”), and payload 815 containing information captured through a signup form which contains addressable user information (e.g., an email address “nuser@homemail.com” for the reward program participant).

In some embodiments, for the sake of efficiency and ease of identification/operation, social media user names can be further transformed or rationalized into another internal representation (e.g., from a user name having a text-based representation to a user ID having a numerical representation) and stored in a streamlined table (e.g., social media user table 700 shown in FIG. 7).

As a non-limiting example, the system is operable to translate the payload (e.g., “{“host”: “brand.com”, “href”: “https://brand.com/getrewards/”, “EMAIL”: “nuser@homemail.com”, “MMERGE1”: “jpapermaster1”, “subscribe”: “JOIN NOW”}”) and extract website/domain information (e.g., “brand.com”), an entity of interest (e.g., “brand”), a social media user name (“jpapermaster1”), and an email address (“nuser@homemail.com”) from the payload.

In this case, the social media user has signed up to be a reward program participant. By mapping a social media user name of the social media user to a reward program participant ID, the system can monitor what they have posted on social media 125, determine (e.g., via reward analyzer 156 or some system logic) whether such an activity/behavior qualifies for an award, and automatically message them and/or deliver the reward(s) directly to them.

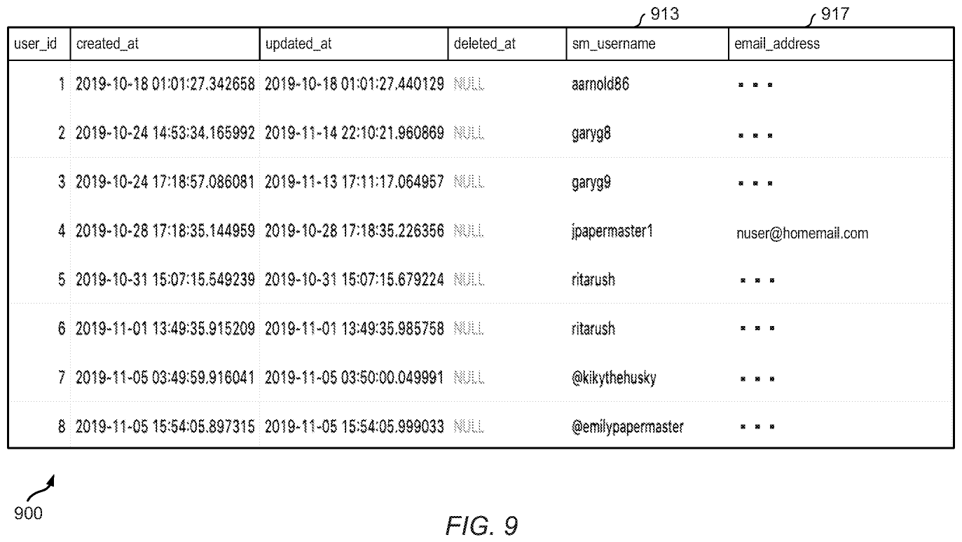

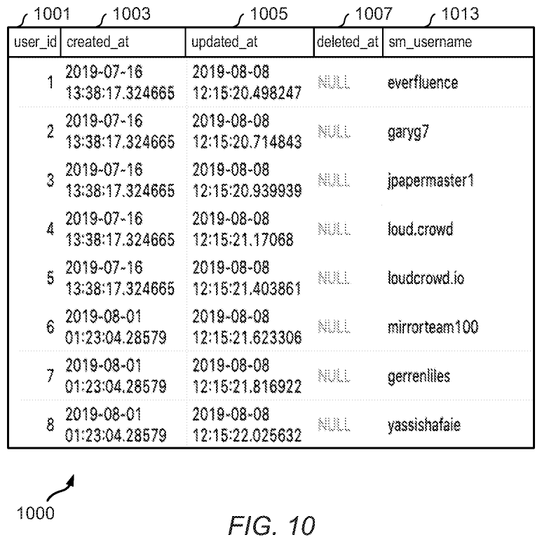

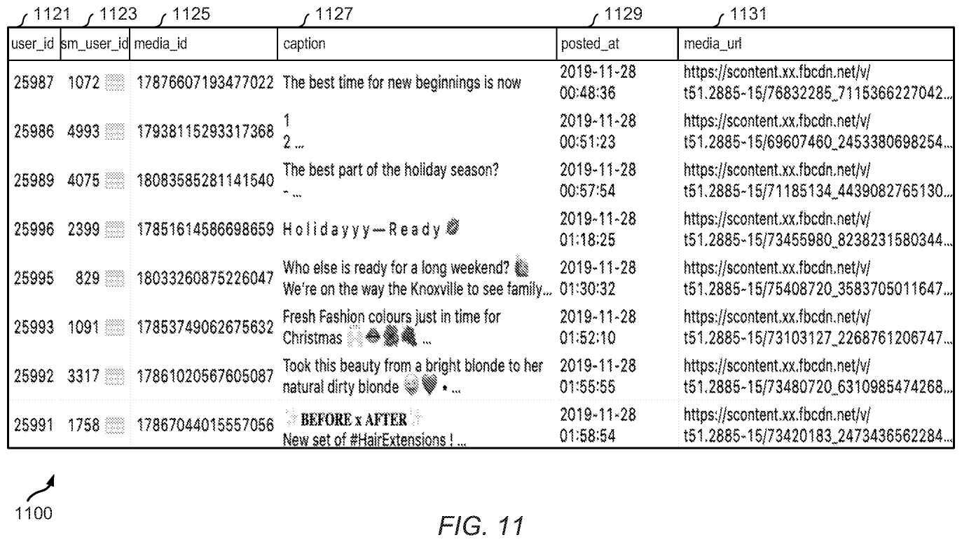

To further streamlined the process, the system may directly associate social media user names with corresponding addressable user information (e.g., email addresses) in a separate table. FIG. 9 shows an example of a user table 900 having a plurality of data fields structured for associating, for instance, a social media user name (“sm_username”) 913 with an email address (“email_adress”) 917. In some embodiments, the system may associate social media user names with an internal ID having a numerical representation. FIG. 10 shows an example of a user table 1000 having a plurality of data fields structured for associating, for instance, a social media user name (“sm_username”) 1013 with an internal user ID 1001. User table 1000 may contain information on individual posts (e.g., when a post is created 1003, updated 1005, or deleted 1007). In some embodiments, the system may track media (e.g., tags, mentions, etc.) posted by social media users on the social media through numerical representations of the social media user IDs mapped to numerical representations of internal user IDs used by the system. FIG. 11 shows an example of a media table 1100 structured for user ID 1121, social media ID 1123, media ID 1125, and details about each post, for instance, caption 1127, posted date 1129, and where the media is located on the social media platform (e.g., media URL 1131).

Once rationalized, data stored in database 154 (e.g., data stored in tables 500-1100) can be utilized (e.g., by reward analyzer 156) to match incoming data from social media source(s) and determine whether a reward program participant qualifies or otherwise is eligible for a reward according to reward structure 152. As a non-limiting example, the monitoring and reward analysis can be performed on a periodic basis (e.g., every hour).

This invention allows an authorized user of an entity or brand to leverage social media APIs (e.g., a Graph API, a mentions API, or both) to capture specific social media data fields for the entity through their entity account on social media 125. For instance, a request GET/{ig-user-id}/tags to get media objects in which the entity or brand has been tagged through their entity account (which is identified by “ig-user-id”) will return a list of tags/fields, including timestamp, “username” (who posted), and corresponding values.

Values in the social media fields (e.g., “username”) thus captured through the entity or brand account can then be combined with other fields (e.g., “participant_id”) captured independently from non-entity users. In this way, the system can determine how many times a user posted to the entity or brand account, check that user's incentive program, and properly, timely, and accurately identify and reward individual reward program participants for tagging and/or mentioning the entity in social media posts on social media 125.

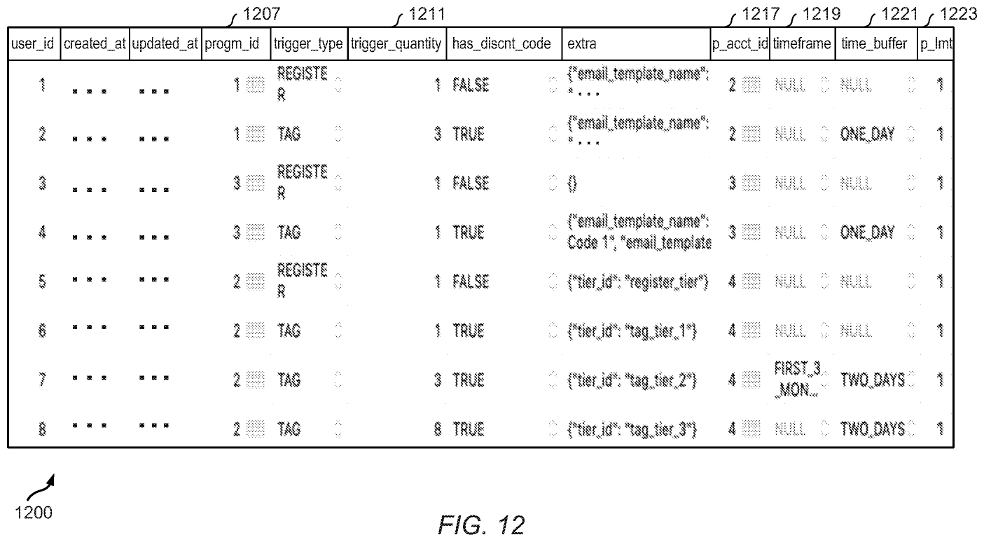

In some embodiments, the system may include additional tables used by the reward analyzer. FIG. 12 shows an example of a program tier table 1200 structured for storing program-related data in a plurality of data fields, including program ID 1207, trigger quantity 1211 (e.g., how many posts are required), program account ID 1217, program eligible timeframe 1219, trigger buffer 1221, (e.g., how spaced out the posts need to be), and reward limit 1223 (e.g., how many times a reward can be redeemed by a reward program participant).

Using the social media APIs, the system can capture every media object in which an entity has been tagged and/or mentioned, and the metadata of that media object. As discussed above, the system can do so with the permission given by the entity to pull images, tags, mentions, etc. (e.g., social media data 127) off of a social media platform 120 via a Graph API, a mentions API, etc. Those skilled in the art recognize that other types of social media APIs may also be utilized.

Included within that metadata is the social media user name of the person who has posted the media and tagged the entity on the social media platform. Separately and independent, the system can also capture identifiable information for the entity's customers in a signup form, a landing page, or the like, as discussed above. Through the signing up process, a username and a unique identifier can be captured and stored in an independent table. With this identifiable information, the system can correlate the user names associated with the media in which the entity is tagged and/or mentioned with the reward program participants who had signed up with the system. This correlation enables the system to analyze the media tagging and/or mentioning the entity and determine whether the reward program participants who tagged/mentioned the entity on the social media platform actually meet or otherwise qualify for a reward, an incentive, a promotion, etc.

For instance, if a user “garyg7” has signed up for a rewards program, the system can query database 154 for the number of posts tagging the entity that were originated by “garyg7.” When that user “garyg7” reaches a milestone (e.g., according to reward structure 152), the system can send them a reward directly using the contact information they have provided during the signup process.

In some cases, the system may perform data filtering to enhance reward program delivery operations. For instance, rather than searching the entire database to see if someone has met the requirements of a reward program, the system can perform data filtering to significantly narrow or reduce the number of posts. As a non-limiting example, the system may begin with the social media table (e.g., social media table 500) and filter out posts that are outside of an acceptable program date range and then filter out posts that are from social media users who have not signed up for a reward program with the system. Realistically, this filtering process can reduce the scope of search by 90-99%.

In some embodiments, the system may start with a reward program participant and examine the media posted by the reward program participant (who is mapped by the system to a social media user name) on the social media platform. The system applies trigger rules to determine what the next trigger is for qualifying a reward program. Alternatively, the system may start with a social media post, check to see if the social media post is associated with a social media social who can be mapped to a reward program participant. If so, the system then checks to see what the trigger is for the reward program participant to qualify for a reward program according to the associated reward structure. Other potential trigger points can include, but are not limited to, trigger quantity, time in between posts, total amounts of times a reward program participant is allowed to post, the frequency and/or timeframe by which a certain number of posts must be made (e.g., 20 posts in a month, three months, or a year), what keywords and/or hashtags must be included in a caption mention, and so on.

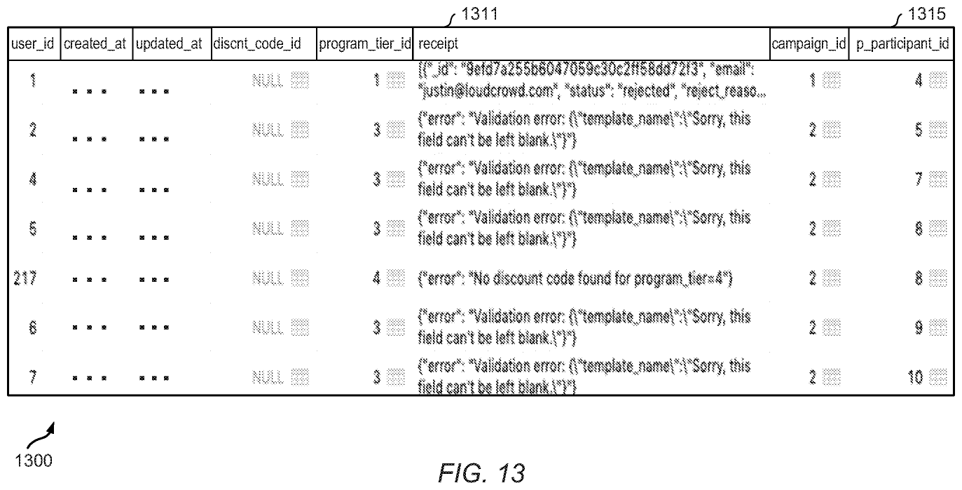

Once the system determines, through the rewards analyzer, that a post is eligible for a reward, the system is operable to:
Create a reward delivery action. To this end, the system will create an event that either sends points to another system (e.g., the entity's customer relationship management system, an email service provider, etc.) or to a user account of the reward program participant, or sends an email to the reward program participant with a discount code.
Create a receipt. As illustrated in FIG. 13, the system creates a receipt 1311 (e.g., in reward delivery table 1300) that shows that a reward delivery action was created for the reward program participant (per the reward program participant ID 1315), and that a post in the media table has been already used for this reward so that the reward program participant will not receive the reward more than once. If the entity has multiple reward programs, a campaign ID may be used to identify individual reward programs.

Accordingly, in some embodiments, the system may implement a method that comprises:
obtaining or receiving input data from a social media platform operating in a first computing environment, the obtaining or receiving performed by a computer system operating in a second computing environment, the input data including at least one of a tag that references an entity or a mention that includes the entity, the computer system operating separately and independently of the social media platform;
transforming, by the computer system, the input data for a reward analysis, the transforming including parsing a payload from the social media platform to extract a social media user name, the tag, the mention, or a combination thereof, the transforming further including translating the social media user name from a text string to a numerical representation, mapping the numerical representation of the social media user name to a reward program participant having addressable user information, and populating a plurality of database tables with media objects and media metadata parsed from the payload from the social media platform and a mapping between the numerical representation of the social media user name and the reward program participant;
analyzing, by the computer system utilizing the plurality of database tables, whether the reward program participant is eligible for a reward according to a reward structure associated with the entity;
determining, by the computer system based on a result from the analyzing, a reward for the reward program participant; and
automatically delivering, by the computer system, the reward to the reward program participant using the addressable user information.

In some embodiments, the computer system, the social media platform, and the entity operating separately and independently of one another. In some embodiments, the obtaining or receiving performed by the computer system can comprise making an API call to a graph API of the social media platform on a periodic basis, wherein the API call is made by the computer system with permission from the entity.

In some embodiments, the method can further include providing a signup form through a reward program page hosted on a server computer that operates in a third computing environment, wherein the third computing environment is separate and operates independently of the first computing environment and of the second computing environment. In some embodiments, the signup form can include a single user input field for a social media user name. In some embodiments, the signup form can include a first user input field for a social media user name and a second user input field for an email address or other addressable user information. In some embodiments, the addressable user information comprises an email address of the reward program participant.

In some embodiments, analyzing whether the reward program participant is eligible for a reward can include applying a rule that specifies a trigger point defined in the reward structure, wherein the trigger point comprises a trigger quantity, a time in between social media posts, a total amount of times a reward program participant is allowed to tag or mention the entity, a frequency or timeframe by which a number of social media posts about the entity is to be made, or a keyword or hashtag that must be included in a social media post.

Embodiments disclosed herein can provide many advantages and benefits. For example, this invention allows entities and/or brands to increase the amount of use-generated content (UGC) that is being created for them on the social media, thus improving brand awareness and customer engagement. It also adds value back to the end users, since many of them already tag entities in photos and/or mention entities in their UGC, but are not rewarded for it. In some embodiments, the invention can be implemented in a cloud computing environment.

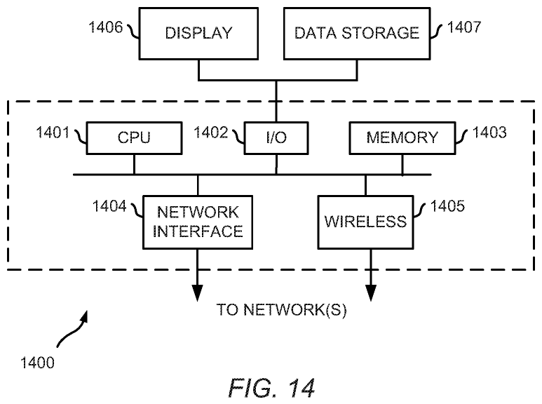

FIG. 14 depicts a diagrammatic representation of a data processing system for implementing embodiments disclosed herein. As shown in FIG. 14, data processing system 1400 may include one or more central processing units (CPU) or processors 1401 coupled to one or more user input/output (I/O) devices 1402 and memory devices 1403. Examples of I/O devices 1402 may include, but are not limited to, keyboards, displays, monitors, touch screens, printers, electronic pointing devices such as mice, trackballs, styluses, touch pads, or the like. Examples of memory devices 1403 may include, but are not limited to, hard drives (HDs), magnetic disk drives, optical disk drives, magnetic cassettes, tape drives, flash memory cards, random access memories (RAMs), read-only memories (ROMs), smart cards, etc. Data processing system 1400 can be coupled to display 1406, information device 1407 and various peripheral devices (not shown), such as printers, plotters, speakers, etc. through I/O devices 1402. Data processing system 1400 may also be coupled to external computers or other devices through network interface 1404, wireless transceiver 1405, or other means that is coupled to a network such as a local area network (LAN), wide area network (WAN), or the Internet.

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a LAN, WAN, and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer-readable medium, hardware circuitry or the like, or any combination and that may be translatable by one or more server machines. Examples of a non-transitory computer-readable medium are provided below in this disclosure.

ROM, RAM, and HD are computer memories for storing computer-executable instructions executable by the CPU or capable of being compiled or interpreted to be executable by the CPU. Suitable computer-executable instructions may reside on a computer-readable medium (e.g., ROM, RAM, and/or HD), hardware circuitry or the like, or any combination thereof. Within this disclosure, the term “computer-readable medium” is not limited to ROM, RAM, and HD and can include any type of data storage medium that can be read by a processor. Examples of computer-readable storage media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like.

The processes described herein may be implemented in suitable computer-executable instructions that may reside on a computer-readable medium (for example, a disk, CD-ROM, a memory, etc.). Alternatively or additionally, the computer-executable instructions may be stored as software code components on a direct access storage device array, magnetic tape, floppy diskette, optical storage device, or other appropriate computer-readable medium or storage device.

Any suitable programming language can be used to implement the routines, methods, or programs of embodiments of the invention described herein, including C, C++, Java, JavaScript, HyperText Markup Language (HTML), Python, or any other programming or scripting code. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps, and operations described herein can be performed in hardware, software, firmware, or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the invention.

It is also within the spirit and scope of the invention to implement in software programming or code any of the steps, operations, methods, routines or portions thereof described herein, where such software programming or code can be stored in a computer-readable medium and can be operated on by a processor to permit a computer to perform any of the steps, operations, methods, routines or portions thereof described herein. The invention may be implemented by using software programming or code in one or more digital computers, by using application specific integrated circuits, programmable logic devices, field programmable gate arrays, optical, chemical, biological, quantum or nanoengineered systems, components and mechanisms may be used. The functions of the invention can be achieved in many ways. For example, distributed or networked systems, components, and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system, or device. The computer-readable medium can be, by way of example only but not by limitation, an electronic, magnetic, optical, electromagnetic, infrared, or semiconductor system, apparatus, system, device, propagation medium, or computer memory. Such computer-readable medium shall be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer-readable media storing computer instructions translatable by one or more processors in a computing environment.

A “processor” includes any, hardware system, mechanism or component that processes data, signals or other information. A processor can include a system with a central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted. The scope of the disclosure should be determined by the following claims and their legal equivalents.

What is claimed is:

1. A method, comprising:
obtaining or receiving input data from a social media platform operating in a first computing environment, the obtaining or receiving performed by a computer system operating in a second computing environment, the input data including at least one of a tag that references an entity or a mention that includes the entity, the computer system operating separately and independently of the social media platform;
transforming, by the computer system, the input data for a reward analysis, the transforming including parsing a payload from the social media platform to extract a social media user name, the tag, the mention, or a combination thereof, the transforming further including translating the social media user name from a text string to a numerical representation, mapping the numerical representation of the social media user name to a reward program participant having addressable user information, and populating a plurality of database tables with media objects and media metadata parsed from the payload from the social media platform and a mapping between the numerical representation of the social media user name and the reward program participant;
analyzing, by the computer system utilizing the plurality of database tables, whether the reward program participant is eligible for a reward according to a reward structure associated with the entity;
determining, by the computer system based on a result from the analyzing, a reward for the reward program participant; and
automatically delivering, by the computer system, the reward to the reward program participant using the addressable user information.

2. The method according to claim 1, wherein the computer system, the social media platform, and the entity operating separately and independently of one another.

3. The method according to claim 1, wherein the obtaining or receiving performed by the computer system comprises making an application programming interface (API) call to a graph API of the social media platform on a periodic basis, wherein the API call is made by the computer system with permission from the entity.

4. The method according to claim 1, further comprising:
providing a signup form through a reward program page hosted on a server computer that operates in a third computing environment, wherein the third computing environment is separate from, and operates independently of, the first computing environment and the second computing environment.

5. The method according to claim 4, wherein the signup form comprises a first user input field for a social media user name and a second user input field for an email address.

6. The method according to claim 1, wherein analyzing whether the reward program participant is eligible for a reward comprises applying a rule that specifies a trigger point defined in the reward structure, wherein the trigger point comprises a trigger quantity, a time in between social media posts, a total amount of times a reward program participant is allowed to tag or mention the entity, a frequency or timeframe by which a number of social media posts about the entity is to be made, or a keyword or hashtag that must be included in a social media post.

7. The method according to claim 1, wherein the addressable user information comprises an email address of the reward program participant.

8. A computer system, comprising:
a processor;
a non-transitory computer-readable medium; and
stored instructions translatable by the processor for:
obtaining or receiving input data from a social media platform operating in a first computing environment, the computer system operating in a second computing environment, the input data including at least one of a tag that references an entity or a mention that includes the entity, the computer system operating separately and independently of the social media platform;
transforming the input data for a reward analysis, the transforming including parsing a payload from the social media platform to extract a social media user name, the tag, the mention, or a combination thereof, the transforming further including translating the social media user name from a text string to a numerical representation, mapping the numerical representation of the social media user name to a reward program participant having addressable user information, and populating a plurality of database tables with media objects and media metadata parsed from the payload from the social media platform and a mapping between the numerical representation of the social media user name and the reward program participant;
analyzing, utilizing the plurality of database tables, whether the reward program participant is eligible for a reward according to a reward structure associated with the entity;
determining, based on a result from the analyzing, a reward for the reward program participant; and
automatically delivering the reward to the reward program participant using the addressable user information.

9. The computer system of claim 8, wherein the computer system, the social media platform, and the entity operating separately and independently of one another.

10. The computer system of claim 8, wherein the obtaining or receiving performed by the computer system comprises making an application programming interface (API) call to a graph API of the social media platform on a periodic basis, wherein the API call is made by the computer system with permission from the entity.

11. The computer system of claim 8, wherein the stored instructions are further translatable by the processor for:
providing a signup form through a reward program page hosted on a server computer that operates in a third computing environment, wherein the third computing environment is separate from, and operates independently of, the first computing environment and the second computing environment.

12. The computer system of claim 11, wherein the signup form comprises a first user input field for a social media user name and a second user input field for an email address.

13. The computer system of claim 8, wherein analyzing whether the reward program participant is eligible for a reward comprises applying a rule that specifies a trigger point defined in the reward structure, wherein the trigger point comprises a trigger quantity, a time in between social media posts, a total amount of times a reward program participant is allowed to tag or mention the entity, a frequency or timeframe by which a number of social media posts about the entity is to be made, or a keyword or hashtag that must be included in a social media post.

14. The computer system of claim 8, wherein the addressable user information comprises an email address of the reward program participant.

15. A computer program product comprising a non-transitory computer-readable medium storing instructions translatable by a processor of a computer system for:
obtaining or receiving input data from a social media platform operating in a first computing environment, the computer system operating in a second computing environment, the input data including at least one of a tag that references an entity or a mention that includes the entity, the computer system operating separately and independently of the social media platform;
transforming the input data for a reward analysis, the transforming including parsing a payload from the social media platform to extract a social media user name, the tag, the mention, or a combination thereof, the transforming further including translating the social media user name from a text string to a numerical representation, mapping the numerical representation of the social media user name to a reward program participant having addressable user information, and populating a plurality of database tables with media objects and media metadata parsed from the payload from the social media platform and a mapping between the numerical representation of the social media user name and the reward program participant;
analyzing, utilizing the plurality of database tables, whether the reward program participant is eligible for a reward according to a reward structure associated with the entity;
determining, based on a result from the analyzing, a reward for the reward program participant; and
automatically delivering the reward to the reward program participant using the addressable user information.

16. The computer program product of claim 15, wherein the computer system, the social media platform, and the entity operating separately and independently of one another.

17. The computer program product of claim 15, wherein the obtaining or receiving performed by the computer system comprises making an application programming interface (API) call to a graph API of the social media platform on a periodic basis, wherein the API call is made by the computer system with permission from the entity.

18. The computer program product of claim 15, wherein the instructions are further translatable by the processor for:
providing a signup form through a reward program page hosted on a server computer that operates in a third computing environment, wherein the third computing environment is separate from, and operates independently of, the first computing environment and the second computing environment.

19. The computer program product of claim 15, wherein the signup form comprises a first user input field for a social media user name and a second user input field for an email address.

20. The computer program product of claim 15, wherein analyzing whether the reward program participant is eligible for a reward comprises applying a rule that specifies a trigger point defined in the reward structure, wherein the trigger point comprises a trigger quantity, a time in between social media posts, a total amount of times a reward program participant is allowed to tag or mention the entity, a frequency or timeframe by which a number of social media posts about the entity is to be made, or a keyword or hashtag that must be included in a social media post.
